(19) United States
(12) Patent Application Publication
(10) Pub. No.: US 2026/0230880 A1
(43) Pub. Date: Aug. 6, 2026

(54) UE Assisted Performance Monitoring Report for AI Based Beam Management with UE Side Model

(71) Applicant: Apple Inc., Cupertino, CA (US)

(72) Inventors: Huaning NIU, San Jose, CA (US); Ankit BHAMRI, Haar (DE); Chunxuan YE, San Diego, CA (US); Haitong SUN, Saratoga, CA (US); Hong HE, San Jose, CA (US); Wei ZENG, Saratoga, CA (US); Weidong YANG, San Diego, CA (US)

(21) Appl. No.: 19/046,144

(22) Filed: Feb. 5, 2025

(51) Int. Cl. H04W 24/10; H04W 24/02

(52) U.S. Cl. CPC H04W 24/10; H04W 24/02

(57) ABSTRACT

An apparatus configured to process, based on signaling received from a base station, configuration information for monitoring a performance of models employing artificial intelligence (AI) or machine learning (ML) (AI/ML) for beam management, process measurements performed for a first set of beams using at least part of the configuration information to obtain a first set of beam measurements, compare the first set of beam measurements to predicted beam results, the predicted beam results obtained by inputting a second set of beam measurements into AI/ML models used for the AI/ML based beam management, wherein a first periodicity of first resources for obtaining the first set of beam measurements is a multiple integer of a second periodicity of second resources for obtaining the second set of beam measurements and generate, for transmission to the base station, a monitoring report relating to the performance of the models.

### BACKGROUND

Artificial intelligence (AI) and/or machine learning (ML) processes, e.g., deep learning neural networks, convolutional neural networks, etc., may be used to augment operations for the air interface in a cellular radio access network (RAN), e.g., 5G New Radio (NR) RAN, 6G RAN, etc. The use cases of AI/ML for the air interface may include beam management (BM).

### SUMMARY

Some example embodiments are related to an apparatus having processing circuitry configured to process, based on signaling received from a base station, configuration information for monitoring a performance of one or more models employing artificial intelligence (AI) or machine learning (ML) (AI/ML) for beam management, process measurements performed for a first set of beams using at least part of the configuration information to obtain a first set of beam measurements, compare the first set of beam measurements to predicted beam results, the predicted beam results obtained by inputting a second set of beam measurements into one or more AI/ML models used for the AI/ML based beam management, wherein a first periodicity of first resources for obtaining the first set of beam measurements is a multiple integer of a second periodicity of second resources for obtaining the second set of beam measurements and generate, for transmission to the base station, a monitoring report relating to the performance of the one or more models.

Other example embodiments are related to an apparatus having processing circuitry configured to process, based on signaling received from a base station, configuration information for monitoring a performance of one or more models employing artificial intelligence (AI) or machine learning (ML) (AI/ML) for beam management, process measurements performed for a first set of beams using at least part of the configuration information to obtain a first set of beam measurements, compare the first set of beam measurements to predicted beam results, the predicted beam results obtained by inputting a second set of beam measurements into one or more AI/ML models used for the AI/ML based beam management and generate, for transmission to the base station, a monitoring report relating to the performance of the one or more models, the monitoring report comprising an aperiodic monitoring report triggered by a first downlink control information (DCI).

### BRIEF DESCRIPTION OF THE DRAWINGS

FIG. 1 shows an example network arrangement according to various example embodiments.

FIG. 2 shows an example UE according to various example embodiments.

FIG. 3 shows an example base station according to various example embodiments.

FIG. 4a shows an example arrangement for AI/ML beam management according to various example embodiments.

FIG. 4b shows a signaling diagram for AI/ML based UE-side prediction for beam management according to various example embodiments.

FIG. 5a shows a diagram for periodic/semi-persistent UE-assisted performance monitoring and reporting according to various example embodiments.

FIG. 5b shows a diagram for periodic/semi-persistent UE-assisted performance monitoring and reporting based on a non-overlapping window according to various example embodiments.

FIG. 5c shows a diagram for periodic/semi-persistent UE-assisted performance monitoring and reporting based on a sliding overlapping window according to various example embodiments.

FIG. 5d shows a diagram for periodic/semi-persistent UE-assisted performance monitoring and reporting on a per-sample basis according to various example embodiments.

FIG. 5e shows an example beam diagram in which Set B comprises a subset of Set A according to various example embodiments.

FIG. 5f shows an example information element (IE) for CSI-AssociatedReportConfigInfo for periodic/semi-persistent performance monitoring according to various example embodiments.

FIG. 6a shows a diagram for aperiodic UE-assisted performance monitoring and reporting according to various example embodiments.

FIG. 6b shows an example information element (IE) for CSI-AssociatedReportConfigInfo for aperiodic performance monitoring using periodic or semi-persistent CSI-RS resources according to various example embodiments.

FIG. 6c shows a diagram for aperiodic UE-assisted performance monitoring and reporting using periodic/semi-persistent measurement resources according to various example embodiments.

FIG. 6d shows a diagram for aperiodic UE-assisted performance monitoring and reporting using a first DCI trigger for measurement and a second DCI trigger for reporting according to various example embodiments.

FIG. 6e shows a diagram for aperiodic UE-assisted performance monitoring and reporting using a single DCI trigger for measurement and reporting after each aperiodic resource according to various example embodiments.

FIG. 6f shows a diagram for aperiodic UE-assisted performance monitoring and reporting using a single DCI trigger for measurement and reporting after a set of aperiodic resource according to various example embodiments.

FIG. 7 shows a diagram for UE-assisted performance monitoring and reporting for temporal prediction according to various example embodiments.

### DETAILED DESCRIPTION

The example embodiments may be further understood with reference to the following description and the related appended drawings, wherein like elements are provided with the same reference numerals. The example embodiments relate to performance monitoring operations for artificial intelligence and/or machine learning (AI/ML) models employed for beam management (BM). In particular, the example embodiments relate to implementation details for user equipment (UE)-assisted performance monitoring wherein the UE calculates and reports a performance metric to the network regarding the prediction performance of a UE-side AI/ML model. Various aspects of these example embodiments relate to configuration and reporting details of the performance metric(s), including timing-related considerations of the configuration/reporting, metrics-related aspects of the reporting, and reference signal (RS)-related aspects of the configuration/reporting. Some example embodiments relate to periodic and/or semi-persistent reporting and other example embodiments relate to aperiodic reporting.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange signaling and/or data with the network. Therefore, the UE as described herein is used to represent any electronic component.

The example embodiments are also described with reference to a 5G New Radio (NR) network. However, reference to a 5G NR network is merely provided for illustrative purposes. The example embodiments may be utilized with any network implementing AI/ML beam management functionalities similar to those described herein, e.g., 5G-Advanced network, 6G network, etc. Therefore, the 5G NR network as described herein may represent any type of network implementing AI/ML beam management functionalities similar to the 5G NR network.

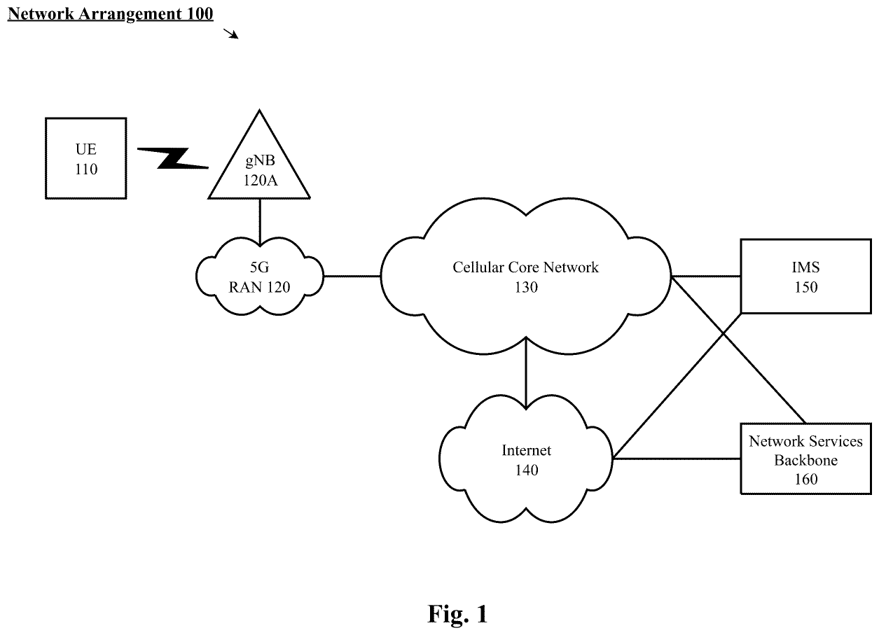

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution RAN, a legacy cellular network, a WLAN, etc.) and the UE 110 may also communicate with networks over a wired connection. With regard to the example embodiments, the UE 110 may establish a connection with the 5G NR RAN 120. Therefore, the UE 110 may have a 5G NR chipset to communicate with the NR RAN 120.

The 5G NR RAN 120 may be a portion of a public land mobile network (PLMN) that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The gNB 120A may include one or more communication interfaces to exchange data and/or information with the UE 110, the corresponding 5G NR RAN 120, the cellular core network 130, the internet 140, etc.

The UE 110 may connect to the 5G NR-RAN 120 via the gNB 120A. Any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific cell (e.g., the gNB 120A). However, as mentioned above, reference to the 5G NR-RAN 120 is merely for illustrative purposes and any appropriate type of RAN may be used.

In addition to the 5G NR RAN 120, the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

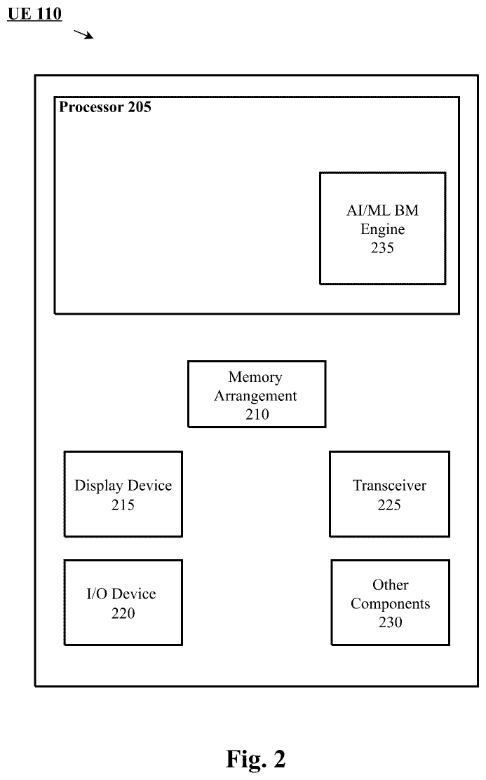

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include an Artificial Intelligence/Machine Learning Beam Management (AI/ML BM) engine 235. The AI/ML BM engine 235 may perform various operations related to beam management. Specifically, the AI/ML BM engine 235 may perform operations such as, but not limited to, performing measurements on a first set of beams (e.g., Set B beams), performing AI/ML inference to predict a second set of beams (e.g., Set A beams), and performing measurements on the second set of beams for performance monitoring. The AI/ML BM engine 235 may perform further operations including comparing the predicted measurement results to the actual measurement results for the second set of beams, calculating one or more performance metrics and reporting the one or more performance metrics to the network. These and other operations are described in greater detail below.

In some examples, beam measurement inputs can be fed to the AI/ML BM engine 235. The AI/ML BM engine 235 can include one or more learning-based and/or non-learning-based models for perceiving, synthesizing, and inferring information. Persons skilled in the art will appreciate that the AI/ML BM engine 235 can include any suitable number of processes to predict a beam in the spatial or temporal domain based on input beam measurement data.

Persons of ordinary skill in the art will appreciate that the AI/ML BM engine 235 can include any suitable machine learning models that are well-known or widely available such as regression techniques, classification techniques, neural networks, and deep learning networks. In instances where the AI/ML BM engine 235 comprises a machine-learning based model, the AI/ML BM engine 235 can be trained to predict a beam based on beam measurement data using one or more well-known or widely available training techniques such as supervised learning, semi-supervised learning, unsupervised learning, and/or reinforcement learning techniques. The training data can include the aforementioned beam measurement data.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode, decode and/or process signals (e.g., signaling from a base station of a network) for implementing any one of the methods described herein.

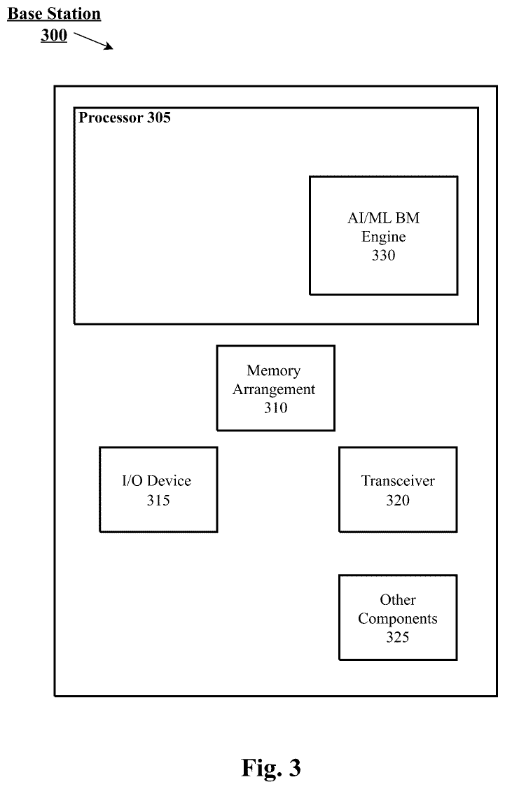

FIG. 3 shows an example base station 300 according to various example embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include an AI/ML BM engine 330. The AI/ML BM engine 330 may perform various operations related to AI/ML BM operations and configuring a UE for AI/ML BM operations. These operations include, but are not limited to, determining channel conditions between the base station 300 and the UE, configuring a UE with parameters for measurement of a first set of beams based on the channel conditions, receiving measurement reports for the first set of beams, determining a second set of beams based on the measurement report, receiving a beam report including a beam index and/or RSRP information for a second set of beams and configuring the UE for UL and DL operations based on information for the second set of beams. These and other operations are described in greater detail below.

In some examples, beam measurement inputs can be fed to the AI/ML BM engine 330. The AI/ML BM engine 330 can include one or more learning-based and/or non-learning-based models for perceiving, synthesizing, and inferring information. Persons skilled in the art will appreciate that the AI/ML BM engine 330 can include any suitable number of processes to predict a beam in the spatial or temporal domain based on input beam measurement data.

Persons of ordinary skill in the art will appreciate that the AI/ML BM engine 330 can include any suitable machine learning models that are well-known or widely available such as regression techniques, classification techniques, neural networks, and deep learning networks. In instances where the AI/ML BM engine 330 comprises a machine-learning based model, the AI/ML BM engine 330 can be trained to predict a beam based on beam measurement data using one or more well-known or widely available training techniques such as supervised learning, semi-supervised learning, unsupervised learning, and/or reinforcement learning techniques. The training data can include the aforementioned beam measurement data.

The above noted engine 330 being an application (e.g., a program) executed by the processor 305 is only an example. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The example embodiments may be implemented in any of these or other configurations of a base station.

The memory arrangement 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode, decode and/or process signals (e.g., signaling from a UE) for implementing any one of the methods described herein.

The example embodiments are also described with regard to radio resource management (RRM), in particular, beam management (BM). Beam management generally refers to a set of procedures configured to acquire and maintain a beam between a base station or TRP and a UE. The terms P1, P2 and P3 refer to processes for beam management during initial access and while in the CONNECTED state. In the P1 process, the base station (e.g., gNB) performs Tx beam sweeping of synchronization signal blocks (SSBs), typically from a set of different beams, and the UE performs reception (Rx) wide beam sweeping from a set of different beams. The UE measures the signal strength (e.g., Reference Signal Received Power (RSRP)) of each of the SSBs of the received beams and selects the best beam to report to the gNB. In the P2 process, the gNB performs beam refinement by performing Tx beam sweeping of Channel State Information-Reference Signal (CSI-RS), possibly from a smaller set of beams than the P1 process, and the UE performs Rx wide beam sweeping from a set of different beams. The P2 Tx beam sweeping may be narrower than that of P1. The UE measures the signal strength (e.g., RSRP) of the CSI-RS of the received beams and selects the best beam to report to the gNB. In the P3 process the gNB (e.g., TRP) repeatedly transmits the same beam and the UE refines its Rx beam.

The example embodiments are also described with regard to AI/ML-based beam management (BM). An AI/ML model may be employed for beam prediction to reduce overhead/latency and improve beam selection. The AI/ML model may be employed for beam prediction in the time domain and/or the spatial domain. In both cases, a set of downlink beams may be measured and used as input to the AI/ML model to predict the best beam within another set of downlink beams. In some example embodiments, the measured parameter/quantity may be L1 RSRP. However, the example embodiments are not limited to this parameter. The measured set of downlink beams may be referred to as “Set B” and the predicted set of downlink beams may be referred to as “Set A.” Set B may be a subset of Set A, or Set B may be different from Set A. For example, the base station may be capable of transmitting 64 beams but the base station may only transmit 4 beams or 8 beams as the Set B of beams. The AI/ML model may then predict a larger set of beams, e.g., the Set A of beams.

The input into the AI/ML model may be measurement results based on measurements performed by the UE on the Set B of beams. The inputs may also include other inputs such as beam forming assumptions and configuration assumptions used by a base station to transmit the Set B of beams. The AI/ML model uses these inputs to predict a beam report for a Set A of beams, which may include a best beam from the Set A and/or L1-RSRP. The AI/ML model may reside at the UE or at the network (e.g., base station).

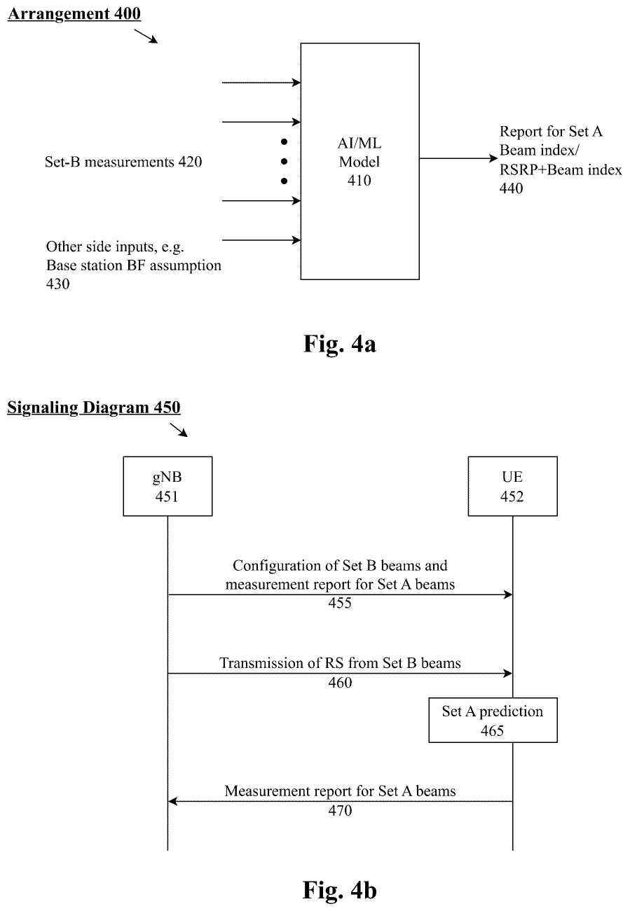

FIG. 4a shows an example arrangement 400 for AI/ML beam management according to various example embodiments. The arrangement 400 shows an AI/ML model 410 that is used for BM. The AI/ML model 410 may reside at the UE or at a network component (e.g., base station).

As shown in FIG. 4, the input into the AI/ML model 410 may be measurements results 420 based on measurements performed by the UE on a set B of beams. The inputs may also include other inputs 430 such as beam forming assumptions and configuration assumptions used by a base station to transmit the set B of beams. The AI/ML model 410 uses these inputs 420 and 430 to predict a beam report 440 for a set A of beams. The beam report 440 may include, for example, beam indices for the set A of beams (e.g., a predicted best beam), Reference Signal Received Power (RSRP) for the set A of beams, etc. The beam report 440 for the set A of beams is not based on actual measurements on the set A of beams but is based on a prediction by the AI/ML model 410 using the inputs 420 and 430. The network may then use the information from the beam report to perform BM operations in the downlink (DL) such as changing a transmission configuration indicator (TCI) for DL transmissions. The AI/ML model 410 may be trained using any data and/or technique and the training of the AI/ML model 410 is beyond the scope of this disclosure.

For UE-side beam prediction, the beam report may include, for example, beam indices for the Set A of beams, Reference Signal Received Power (RSRP) for the Set A of beams, etc. The report may include the top K beam measurements (predictions) along with the beam index or may include only the top K beam indices. In a first case, the AI/ML model 410 may be resident on the UE and the UE may perform the prediction and report the set A of beams to the network including the beam index only, e.g., the beam index of the best beam of the set A of beams or a predefined number (K) of best beams of the set A of beams where K>1. The “best” beam may be defined in any manner. For example, the best beam may be based on the predicted RSRP of the beams. The example embodiments are not limited to reporting the best beams. In a second case, the AI/ML model 410 may be resident on the UE and the UE may perform the prediction and report the set A of beams to the network including the beam index and the RSRP corresponding to the beam index. Again, this reporting may be limited to the best beam of the set A of beams or a predefined number (K) of best beams of the set A of beams where K>1. However, the example embodiments are not limited to reporting the best beams.

FIG. 4b shows a signaling diagram 450 for AI/ML based UE-side prediction for beam management according to various example embodiments. The diagram 450 includes a gNB 451 and a UE 452. In 455, the gNB 451 configures the UE 452 with Set B beams and a measurement report for Set A beams. In 460, the gNB 451 transmits RS from the Set B beams for measurement by the UE 452. In 465, the UE 452 predicts the Set A beams. In 470, the UE 452 transmits a measurement report to the gNB 451 corresponding to the Set A beams.

Beam management Case 1 (BM-Case1) relates to spatial-domain DL Tx beam prediction for Set A of beams based on measurement results of Set B of beams. Beam management Case 2 (BM-Case2) relates to temporal DL Tx beam prediction for Set A of beams based on the historic measurement results of Set B of beams. It is an objective to specify necessary signaling/mechanism(s) to facilitate life cycle management (LCM) operations specific to the BM AI/ML use cases, e.g., data collection for training/inferencing, performance monitoring, etc., and to enable method(s) to ensure consistency between training and inference regarding network-side additional conditions (if identified) for inference at UE. It is an objective to specify a common framework design to support both BM-Case1 and BM-Case2.

For BM-Case1 and BM-Case2 with a UE-side AI/ML model, it is an objective to support Type 1 performance monitoring including network-side performance monitoring and UE-assisted performance monitoring. In either case, the network may evaluate the performance of the AI/ML function and decide whether to deactivate the current AI/ML function and/or switch to a different AI/ML function or fall back to legacy procedure. In network-side performance monitoring, the UE sends a report to the network for the network to calculate the performance metric. The content of the report may include measurement results from a resource set for monitoring, e.g., L1-RSRP and/or RS index for ground truth reporting. This report may be configured and triggered by the network. In UE-assisted performance monitoring, the UE calculates a performance metric and reports the performance metric to the network.

Regarding the contents of the report for UE-assisted performance monitoring for BM-Case1 and BM-Case2 with a UE-sided AI/ML model, support performance metric(s) comprising the top 1 or top K>1 beam prediction accuracy (with or without margin) by comparing the prediction results with the actual Top 1 or Top K beams based on the measurements from a resource set/resources for monitoring may be supported. In other words, the performance metric quantifies the accuracy of the prediction, in particular, whether the actual best beam is among the top K predicted beams. For example, Top-1 accuracy indicates the actual best beam was the predicted best beam while Top-3 accuracy indicates the actual best beam was within the predicted three best beams.

Additionally, performance metric(s) comprising L1-RSRP difference information based on actual measurement of the L1-RSRP of one or more of the Top K predicted beams and L1-RSRP measurements from a resource set/resources for monitoring may also be used. Other details including how to configure the resource set/resources for monitoring, including, e.g., whether/how to use full set of Set A for measurement and, if the full Set A is not configured, whether/how to obtain the measurement of the predicted Top 1 or Top K beam for calculating the prediction accuracy or the RSRP difference, were left for further study.

The CSI reporting framework may be reused for the configuration for monitoring result report in L1 signaling. Dedicated resource set(s) for monitoring and report configuration for monitoring may be configured in a dedicated CSI report configuration used for monitoring. The ID of an inference report configuration may be configured for monitoring to link the inference report configuration and monitoring report configuration. How to identify the connection between RSs in the resource set(s) for monitoring and Set A beams, whether to support all the combinations on time domain behavior of the reportConfigType for inference report and the reportConfigType for monitoring report (e.g., how the inference report and the monitoring report are linked), and timing related issues may also be addressed.

According to various example embodiments described herein, implementation details are provided for UE beam reporting for performance monitoring, including timing-related aspects of configuration and reporting, metrics-related aspects of reporting calculation, and RS-related aspects of configuration and reporting. Some example embodiments are related to beam prediction accuracy. As described above, prediction accuracy refers to metrics for indicating whether an actual best beam is among the top K predicted beams. In other example embodiments, other types of metrics are also discussed.

In some aspects of these example embodiments, the UE may report performance metrics for beam prediction accuracy in a periodic or semi-persistent CSI report. Based on current agreement, set B RS for inference and set A RS for performance monitoring may be configured in CSI-ReportConfig for monitoring metric.

In one aspect of these example embodiments, periodic/semi-persistent reporting is supported for different periodicities of Set B resources and Set A resources. In some example embodiments, the Set A RS periodicity is a multiple integer of the Set B RS periodicity. In some example embodiments, a fixed offset in time is configured to link the set B resources with set A resources for the performance monitoring calculation.

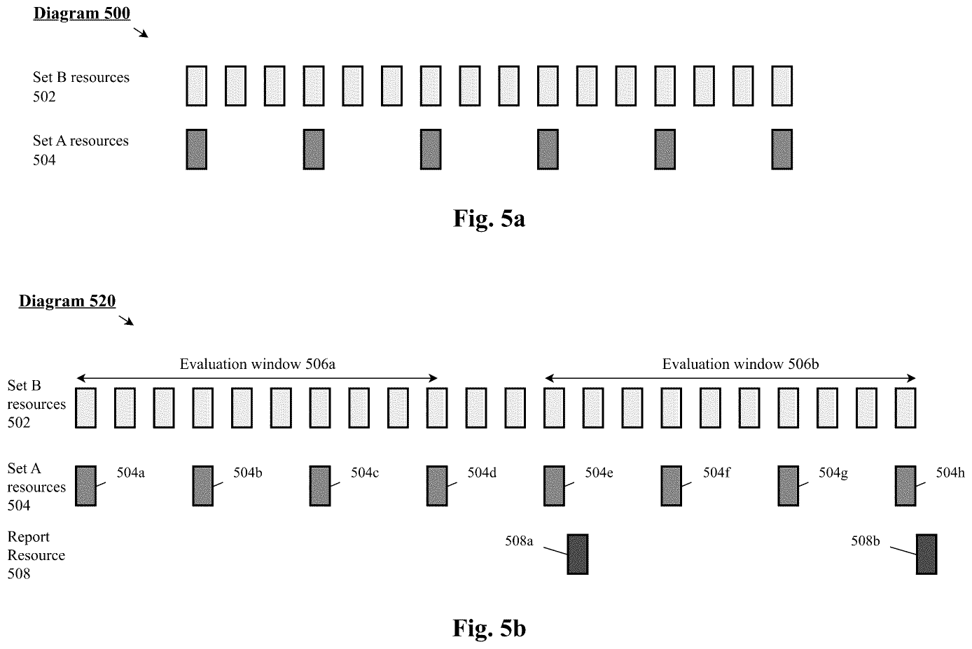

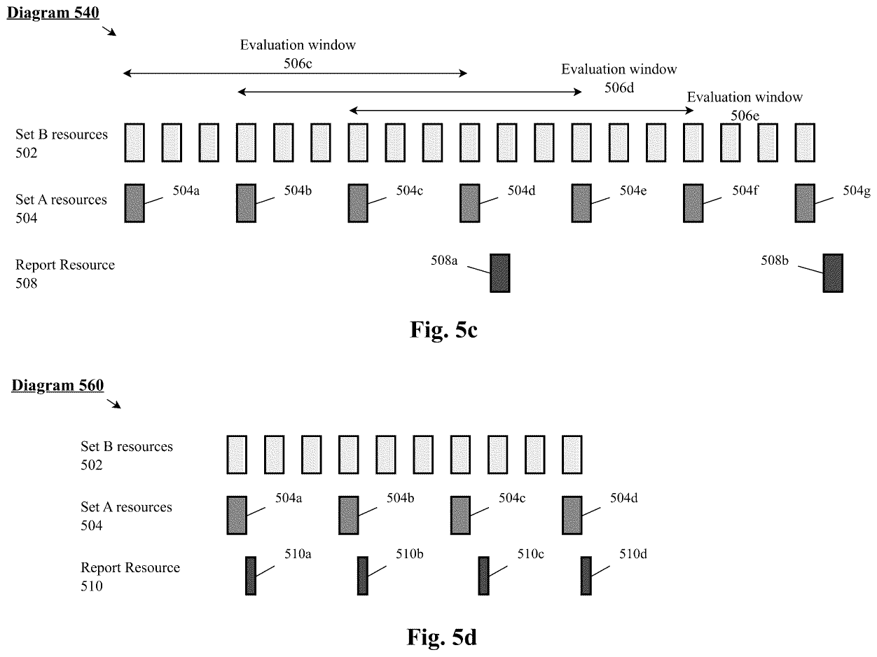

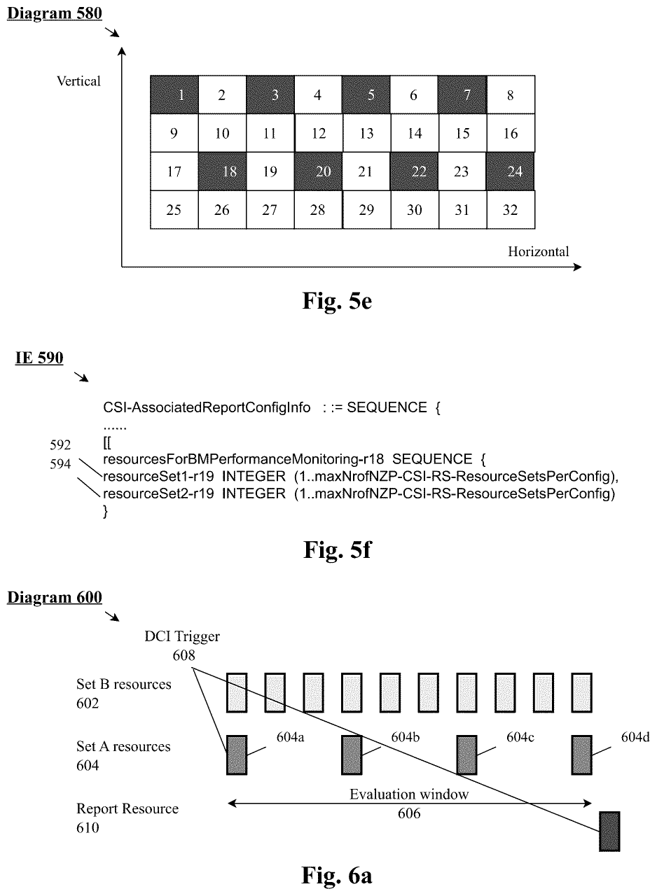

FIG. 5a shows a diagram 500 for periodic/semi-persistent UE-assisted performance monitoring and reporting according to various example embodiments. In this example, first periodic resources 502 are configured for Set B RS (for inference) and second periodic resources 504 are configured for Set A RS (for performance monitoring). In some example embodiments, the periodicity of the second resources 504 is a multiple integer of the periodicity of the first resources 502. In this example, the periodicity of the second resources 504 is 3 times the periodicity of the first resources 502. In this example, the offset between the resources is 0, e.g., the first resources 502 are in the same slot as the second resources 504.

In another aspect of these example embodiments, a periodic reporting periodicity is based on an evaluation window. The evaluation window may be configured in the report configuration for the accuracy calculation. In some example embodiments, the report is based on a non-overlapping window. In other example embodiments, the report is based on a sliding overlapping window.

FIG. 5b shows a diagram 520 for periodic/semi-persistent UE-assisted performance monitoring and reporting based on a non-overlapping window according to various example embodiments. Similar to the diagram 500 of FIG. 5a, the first periodic resources 502 are configured for Set B RS and the second periodic resources 504 are configured for Set A RS. In this example, a first evaluation window 506a includes four Set A RS (504a-d) and the second evaluation window 506b includes four Set A RS (504e-h). A first report resource 508a is offset after the first evaluation window 506a and a second report resource 508b is offset after the second evaluation window 506b.

FIG. 5c shows a diagram 540 for periodic/semi-persistent UE-assisted performance monitoring and reporting based on a sliding overlapping window according to various example embodiments. Similar to the diagram 500 of FIG. 5a, the first resources 502 are configured for Set B RS and the second resources 504 are configured for Set A RS. In this example, a first evaluation window 506c includes four Set A RS (504a-d); a second evaluation window 506d includes four Set A RS (504b-e); and a third evaluation window 506e includes four Set A RS (504c-f). A first report resource 508c is offset after the first evaluation window 506c; a second report resource 508d is offset after the second evaluation window 506d; and a third report resource 508e is offset after the third evaluation window 506e. Accordingly, in this example, the periodicity of the report is equal to the periodicity of the Set A resources.

In another aspect of these example embodiments, the report is a per sample report (e.g., one-shot) for a single measurement opportunity. In other words, each Set A resource for monitoring has a corresponding report resource for reporting prediction accuracy of the Set A resource. In some example embodiments, 1 bit indicates whether this particular inference report is accurate or not accurate. In some example embodiments, a bit value of 1 indicates the measured best beam of the Set A resource is part of the predicted top K (K>=1) beams of the Set A inference and a bit value of 0 indicates the measured best beam of the Set A resource is not part of the predicted top K (K>=1) beams of the Set A inference. In these example embodiments, it is up to network implementation to calculate the beam prediction accuracy (e.g., averaging) based on a set of periodic/semi-persistent feedback.

FIG. 5d shows a diagram 560 for periodic/semi-persistent UE-assisted performance monitoring and reporting on a per-sample basis according to various example embodiments. Similar to the diagram 500 of FIG. 5a, the first resources 502 are configured for Set B RS and the second resources 504 are configured for Set A RS. In this example, a first report resource 510a is offset after a first Set A measurement 504a; a second report resource 510b is offset after a second Set A measurement 504b; a third report resource 510c is offset after a third Set A measurement 504c; and a fourth report resource 510d is offset after a fourth Set A measurement 504d. In this example, a report sent in each of the report resources 510 includes a single bit indicating whether the prediction was accurate.

In an alternative embodiment, an evaluation window is configured and the monitoring report can include the number of predictions within the evaluation window that are accurate. For example, if the evaluation window includes 4 set A RS and, for 3 of the set A RS, the measured best beam of the set A resource is part of the predicted top K beams, then the UE can send 3 as the report.

In some example configurations, Set B resources may be a subset of Set A resources. FIG. 5e shows an example beam diagram 580 in which Set B comprises a subset of Set A according to various example embodiments. In this example, Set B comprises beam indices {1, 3, 5, 7, 18, 20, 22, 24) and Set A comprises beam indices {1-32}

In another aspect of these example embodiments, if the Set B resources are a subset of the Set A resources, the Set A resources for performance monitoring may be configured by associating the Set B resource and a separate resource together, using CSI-AssociatedReportConfigInfo. Considering the example beam diagram 580 of FIG. 5e, the Set B resources correspond to beam indices {1, 3, 5, 7, 18, 20, 22, 24) and the separate resource corresponds to beam indices {2, 4, 6, 8-17, 19, 21, 23, 25-32}, e.g., comprises the beam indices of Set A not included in Set B. FIG. 5f shows an example information element (IE) 590 for CSI-AssociatedReportConfigInfo for periodic/semi-persistent performance monitoring according to various example embodiments. In this example, the IE 590 includes a first resource set 592, e.g., corresponding to the resources for inference on the Set B beams, and a second resource set 594, e.g., corresponding to the remaining resources for performance monitoring on the Set A beams.

In some aspects of these example embodiments, the UE may report performance metrics for beam prediction accuracy in an aperiodic CSI report. In legacy CSI reporting, a single DCI may trigger the aperiodic CSI report and the corresponding aperiodic CSI-RS resources. For a performance monitoring report, to calculate beam prediction accuracy, multiple CSI-RS are required.

In one aspect of these example embodiments, aperiodic reporting is supported for K>1 aperiodic CSI-RS resources in a same CSI-RS resource set where the separation between 2 consecutive aperiodic CSI-RS resources is m milli-seconds (e.g., m=160, 320, 640 ms). In some example embodiments, the aperiodic CSI-RS resources and the monitoring report are triggered by a single DCI. In other example embodiments, the triggered monitoring report is offset after the last ap-CSI-RS resource in the time domain. The offset value may be configurable in the CSI report.

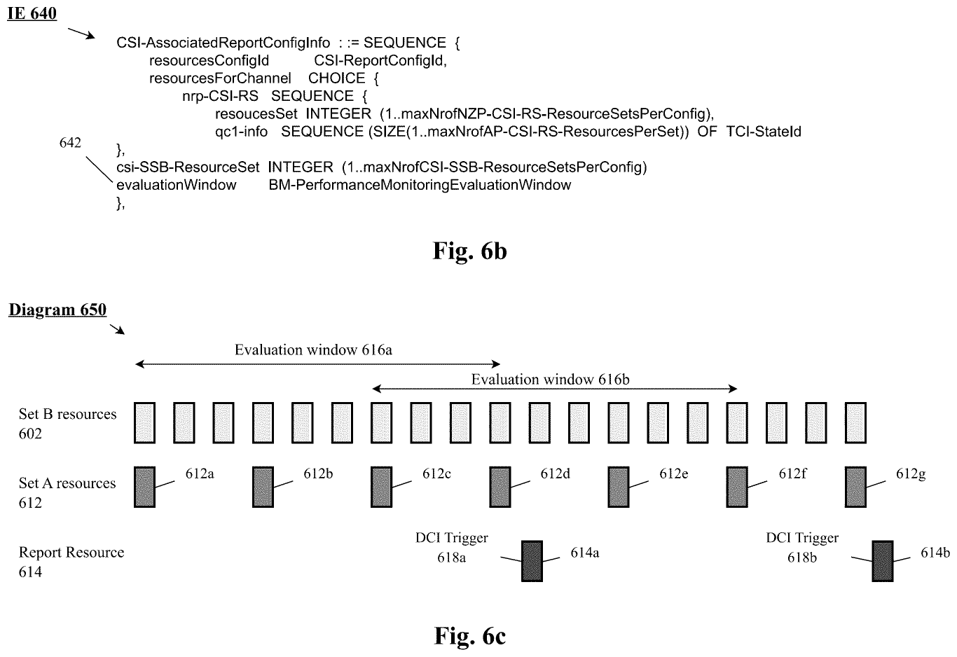

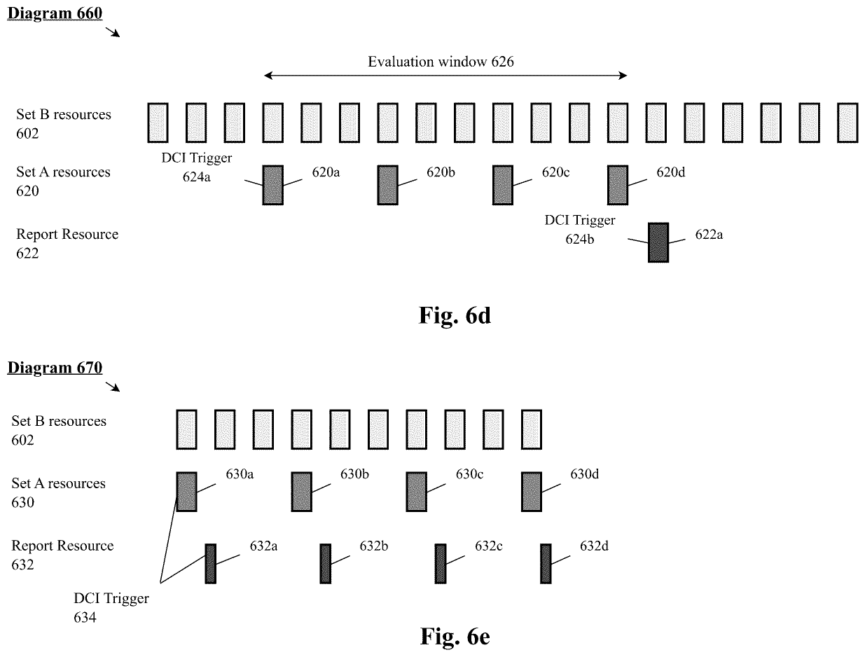

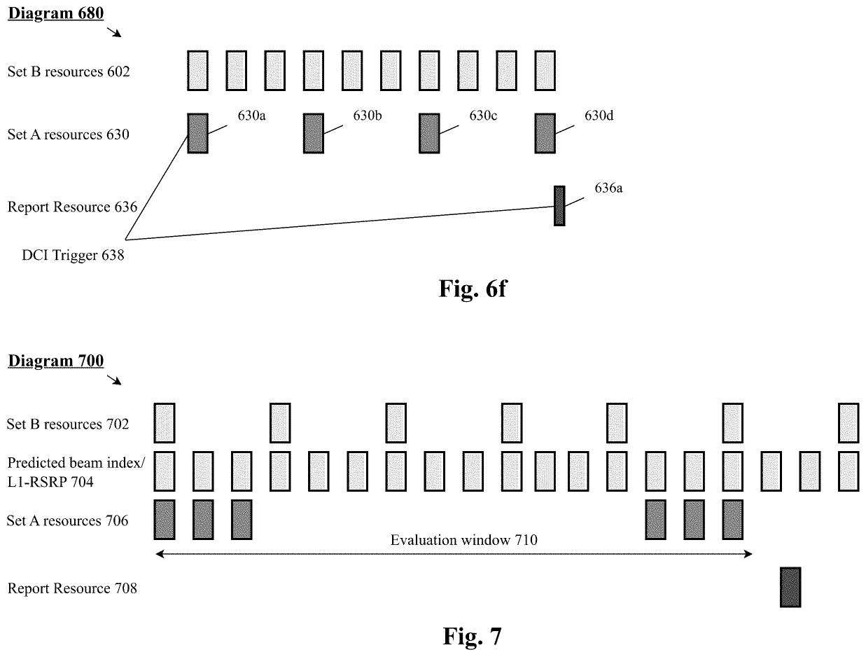

FIG. 6a shows a diagram 600 for aperiodic UE-assisted performance monitoring and reporting according to various example embodiments. In this example, first periodic resources 602 are configured for Set B RS (for inference) and second aperiodic resources 604 are configured for Set A RS (for performance monitoring). In some example embodiments, the aperiodic performance monitoring configuration includes a number K>1 of consecutive CSI-RS resources. In this example, the aperiodic performance monitoring configuration includes four resources, e.g., Set A resources 604-d, to be measured over an evaluation window 606. The Set A resources 604 and a report resource 610 may be triggered by a single DCI 608. The report resource 610 is offset from the last ap-CSI-RS resource 604d by a configured value.

Due to the large delay in triggering performance monitoring report, an alternative is to use the ap-CSI report together with periodic and semi-persistent CSI-RS of set A configuration.

In another aspect of these example embodiments, in the RRC configuration of the associated list of the ap-CSI report, an evaluation window is configured for periodic/sp CSI-RS. FIG. 6b shows an example information element (IE) 640 for CSI-AssociatedReportConfigInfo for aperiodic performance monitoring using periodic or semi-persistent CSI-RS resources according to various example embodiments. In this example, the IE 640 includes an evaluation window 642 for periodic/sp CSI-RS resources that is included in the associated list of the ap-CSI report.

Accordingly, the UE may only buffer measurements for the duration of the evaluation window. When the DCI trigger is received for the aperiodic report, the UE may calculate the performance metric according to the buffered measurement results.

FIG. 6c shows a diagram 650 for aperiodic UE-assisted performance monitoring and reporting using periodic/semi-persistent measurement resources according to various example embodiments. In this example, first periodic resources 602 are configured for Set B RS (for inference) and second periodic resources 612 are configured for Set A RS (for performance monitoring). The Set A resources 612 (612a-g) are configured with an evaluation window so that measurements on these resources are buffered by the UE only for the duration of the evaluation window. In some example embodiments, when a DCI trigger 618 is received for an aperiodic report resource 614, the UE calculates the performance metric(s) for the buffered measurements and transmits the aperiodic report. In this example, a first DCI trigger 618a is received after Set A resource 612d, such that a first evaluation window 616a includes Set A resources 612a-d and the performance metric(s) for a first aperiodic report sent in triggered resource 614a is based on the Set A resources 612a-d. In this example, a second DCI trigger 618b is received after Set A resource 612f, such that a second evaluation window 616b includes Set A resources 612c-f and the performance metric(s) for a second aperiodic report sent in triggered resource 614b is based on the Set A resources 612c-f.

In another aspect of these example embodiments, aperiodic reporting is supported for K>1 aperiodic CSI-RS resources in a same CSI-RS resource set where the separation between 2 consecutive aperiodic CSI-RS resources is m milli-seconds (e.g., m=160, 320, 640 ms) wherein the ap-CSI-RS resources are triggered by a first DCI and the corresponding report is triggered by a second DCI. In some example embodiments, the evaluation window is the same length as K>1. In the RRC configuration of the associated list of the ap-CSI report, as shown in FIG. 6b, an evaluation window is configured for the aperiodic CSI-RS.

FIG. 6d shows a diagram 660 for aperiodic UE-assisted performance monitoring and reporting using a first DCI trigger for measurement and a second DCI trigger for reporting according to various example embodiments. In this example, first periodic resources 602 are configured for Set B RS (for inference) and second aperiodic resources 620 are configured for Set A RS (for performance monitoring). In this example, a first DCI trigger 624a is received to trigger the Set A resources 620, starting with resource 620a. The UE measures resources 620a-d, after which a second DCI trigger 624b is received to trigger a report resource, e.g., report resource 622a, after Set A resource 620d. Accordingly, the UE calculates the performance metric(s) for the measurements on Set A resources 620a-d (evaluation window 626) and transmits the aperiodic report in report resource 622a.

In another aspect of these example embodiments, aperiodic reporting is supported for prediction accuracy wherein each aperiodic CSI-RS monitoring instance is evaluated and reported separately, e.g., one-by-one. In some example embodiments, the same DCI triggers the set of ap-CSI-RS resources and an associated monitoring report after each ap-CSI-RS resource.

FIG. 6e shows a diagram 670 for aperiodic UE-assisted performance monitoring and reporting using a single DCI trigger for measurement and reporting after each aperiodic resource according to various example embodiments. In this example, first periodic resources 602 are configured for Set B RS (for inference) and second aperiodic resources 630 are configured for Set A RS (for performance monitoring). In this example, the aperiodic performance monitoring configuration includes four Set A resources. The Set A resources 604 and monitoring report resources 632 for each Set A measurement are triggered by a single DCI 634, e.g., a monitoring report 632 resource is offset after each of the four Set A resources 630. In this example, a first report resource 632a is offset after a first Set A measurement 630a; a second report resource 632b is offset after a second Set A measurement 630b; a third report resource 632c is offset after a third Set A measurement 630c; and a fourth report resource 632d is offset after a fourth Set A measurement 630d. In this example, a report sent in each of the report resources 632 includes a single bit indicating whether the prediction was accurate.

In another embodiment, the same DCI triggers the set of ap-CSI-RS resources and a single monitoring report after the last ap-CSI-RS resource. The triggered monitoring report is offset after the last ap-CSI-RS resource by an offset value configurable in the CSI report. In this case, the report may comprise a bitmap.

FIG. 6f shows a diagram 680 for aperiodic UE-assisted performance monitoring and reporting using a single DCI trigger for measurement and reporting after a set of aperiodic resource according to various example embodiments. In this example, first periodic resources 602 are configured for Set B RS (for inference) and second aperiodic resources 630 are configured for Set A RS (for performance monitoring). In this example, the aperiodic performance monitoring configuration includes four Set A resources. The Set A resources 630 and monitoring report resource 636 for a set of Set A measurements are triggered by a single DCI 638, e.g., a single monitoring report resource 636a is offset after the last of the four Set A resources 630, e.g., resource 630d. The offset for the report resource 636a from the last ap-CSI-RS resource is configured in the CSI report config. In this example, a report sent in report resources 636a includes a bit map indicating whether the prediction was accurate for each of the set A resources 630.

In some aspects of these example embodiments, the content of the report may comprise a L1-RSRP difference. The report configuration for periodic, semi-persistent and aperiodic reporting may be used as described in the above embodiments, with the following additional considerations.

In one aspect of these example embodiments, when an evaluation window is configured for performance metric(s) comprising an L1-RSRP difference, when K-1 (best K), the reported value comprises (measured L1-RSRP of the best beam-the predicted L1-RSRP). In some example embodiments, the report may be quantized. In one option, the same quantization scheme as the existing L1-RSRP report in current specification (e.g., 7 bits) may be used. In a second option, a finer quantization scheme may be used relative to L1-RSRP, e.g., a 0.5 dB quantization level.

When K>1, e.g., K=4, for each instance, the performance metrics for L1-RSRP difference for each set A/set B measurement may be defined as the following options. In a first option, the performance metric may comprise the mean of (measured L1-RSRP of the best beam—the predicted L1-RSRP of best beam). In a second option, the performance metric may comprise the sum of (measured L1-RSRP of top-K beams-the predicted L1-RSRP of top K beams). In a third option, the performance metric may comprise the maximum of (measured L1-RSRP of top-K beams—the predicted L1-RSRP of top K beams). In a fourth option, the performance metric may comprise the minimum of (measured L1-RSRP of top-K beams—the predicted L1-RSRP of top K beams). In each option, each instance of L1-RSRP difference over the window may be reported separately or the average over the window may be reported.

In some aspects of these example embodiments, BM-Case2 (e.g., temporal prediction) is considered in more detail. In general, the proposals described above for BM-Case1 (spatial prediction) may be applied to BM-Case2, particularly if the predicted beam measurements are for a single future slot. However, if greater than one future slot is predicted, e.g., 3 slots, then additional details are necessary for specifying the reporting.

In one aspect of these example embodiments, for beam prediction accuracy for BM-Case2 performance monitoring, if a beam index and/or L1-RSRP is predicted for multiple future slots then each future instance is calculated separately. The further in time the prediction is made the worse the accuracy, such that averaging the performance metrics would degrade the quality of the information, e.g., knowing which prediction was better or worse.

FIG. 7 shows a diagram 700 for UE-assisted performance monitoring and reporting for temporal prediction according to various example embodiments. In this example, first periodic resources 702 are configured for Set B RS (e.g., for inference) and the UE predicts beam indices/L1-RSRP for future time slots 704. Second resources 706 are configured for Set A RS (e.g., for performance monitoring). In this example, the performance monitoring configuration includes six Set A resources over evaluation window 710. The performance metric for each Set A resource 706 is calculated separately and reported in report resource 708.

### EXAMPLES

In a first example, a method, comprising processing, based on signaling received from a base station, configuration information for monitoring a performance of one or more models employing artificial intelligence (AI) or machine learning (ML) (AI/ML) for beam management, processing measurements performed for a first set of beams using at least part of the configuration information to obtain a first set of beam measurements, comparing the first set of beam measurements to predicted beam results, the predicted beam results obtained by inputting a second set of beam measurements into one or more AI/ML models used for the AI/ML based beam management, wherein a first periodicity of first resources for obtaining the first set of beam measurements is a multiple integer of a second periodicity of second resources for obtaining the second set of beam measurements and generating, for transmission to the base station, a monitoring report relating to the performance of the one or more models.

In a second example, the method of the first example, wherein a third periodicity of third resources for transmitting the monitoring report is a multiple integer of the first periodicity.

In a third example, the method of the first example, wherein a fixed offset in time is configured to link the first resources and the second resources.

In a fourth example, the method of the first example, wherein an evaluation window is configured for obtaining the first set of beam measurements.

In a fifth example, the method of the fourth example, wherein a first evaluation window for a first monitoring report is non-overlapping with a second evaluation window for a second monitoring report.

In a sixth example, the method of the fourth example, wherein a first evaluation window for a first monitoring report overlaps with a second evaluation window for a second monitoring report.

In a seventh example, the method of the first example, wherein a respective monitoring report is generated for each sample measurement of the first set of beams.

In an eighth example, the method of the seventh example, wherein the monitoring report includes prediction accuracy results and a single bit indicates whether the predicted beam results are accurate.

In a ninth example, the method of the first example, wherein the first resources are configured by associating the second resources with a separate resource using CSI-AssociatedReportConfigInfo.

In a tenth example, the method of the first example, wherein the monitoring report includes L1 reference signal received power (L1-RSRP) difference results.

In an eleventh example, the method of the tenth example, wherein, when a top K=1 best beam is reported, the reported value comprises (measured L1-RSRP of the best beam—predicted L1-RSRP), wherein the monitoring report is quantized with a finer quantization scheme than a L1-RSRP report.

In a twelfth example, the method of the tenth example, wherein, when top K>1 best beams are reported, the reported value comprises a mean, a sum, a maximum or a minimum of (measured L1-RSRP of the best beam—predicted L1-RSRP).

In a thirteenth example, the method of the tenth example, wherein an evaluation window is configured for the first set of beams, wherein a respective monitoring report is generated for each sample measurement of the first set of beams or a single monitoring report is generated comprising an average over the evaluation window.

In a fourteenth example, the method of the first example, wherein the predicted beam results comprise temporal predictions for future slots, wherein each future slot is calculated separately.

In a fifteenth example, one or more processors configured to perform any of the methods of the first through thirteenth examples.

In a sixteenth example, a user equipment (UE) configured to perform any of the methods of the first through thirteenth examples.

In a seventeenth example, a method, comprising processing, based on signaling received from a base station, configuration information for monitoring a performance of one or more models employing artificial intelligence (AI) or machine learning (ML) (AI/ML) for beam management, processing measurements performed for a first set of beams using at least part of the configuration information to obtain a first set of beam measurements, comparing the first set of beam measurements to predicted beam results, the predicted beam results obtained by inputting a second set of beam measurements into one or more AI/ML models used for the AI/ML based beam management and generating, for transmission to the base station, a monitoring report relating to the performance of the one or more models, the monitoring report comprising an aperiodic monitoring report triggered by a first downlink control information (DCI).

In an eighteenth example, the method of the seventeenth example, wherein first resources for obtaining the first set of beam measurements comprise multiple aperiodic resources triggered by the first DCI.

In a nineteenth example, the method of the eighteenth example, wherein third resources for transmitting the monitoring report are configured with an offset value after a last aperiodic resource in time of the aperiodic resources.

In a twentieth example, the method of the seventeenth example, wherein first resources for obtaining the first set of beam measurements comprise periodic or semi-persistent resources.

In a twenty first example, the method of the twentieth example, wherein an evaluation window is configured for the first resources in CSI-AssociatedReportConfigInfo associated with the aperiodic monitoring report.

In a twenty second example, the method of the seventeenth example, wherein first resources for obtaining the first set of beam measurements comprise multiple aperiodic resources triggered by a second DCI.

In a twenty third example, the method of the twenty second example, wherein an evaluation window is configured for the first resources in CSI-AssociatedReportConfigInfo associated with the aperiodic monitoring report, the evaluation window corresponding to the multiple aperiodic resources.

In a twenty fourth example, the method of the seventeenth example, wherein first resources for obtaining the first set of beam measurements comprise multiple aperiodic resources triggered by the first DCI, the first DCI triggering a respective monitoring report for each of the multiple aperiodic resources, each respective monitoring report comprising a single bit.

In a twenty fifth example, the method of the seventeenth example, wherein first resources for obtaining the first set of beam measurements comprise multiple aperiodic resources triggered by the first DCI, the first DCI triggering the monitoring report after a last aperiodic resource of the multiple aperiodic resources, the monitoring report comprising a bitmap including a bit for each of the multiple aperiodic resources.

In a twenty sixth example, the method of the seventeenth example, wherein the monitoring report includes L1 reference signal received power (L1-RSRP) difference results.

In a twenty seventh example, the method of the twenty sixth example, wherein, when a top K=1 best beam is reported, the reported value comprises (measured L1-RSRP of the best beam-predicted L1-RSRP), wherein the monitoring report is quantized with a finer quantization scheme than a L1-RSRP report.

In a twenty eighth example, the method of the twenty sixth example, wherein, when top K>1 best beams are reported, the reported value comprises a mean, a sum, a maximum or a minimum of (measured L1-RSRP of the best beam-predicted L1-RSRP).

In a twenty ninth example, the method of the twenty sixth example, wherein an evaluation window is configured for the first set of beams, wherein a respective monitoring report is generated for each sample measurement of the first set of beams or a single monitoring report is generated comprising an average over the evaluation window.

In a thirtieth example, the method of the seventeenth example, wherein the predicted beam results comprise temporal predictions for future slots, wherein each future slot is calculated separately.

In a thirty first example, one or more processors configured to perform any of the methods of the seventeenth through thirtieth examples.

In a thirty second example, a user equipment (UE) configured to perform any of the methods of the seventeenth through thirtieth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
process, based on signaling received from a base station, configuration information for monitoring a performance of one or more models employing artificial intelligence (AI) or machine learning (ML) (AI/ML) for beam management;
process measurements performed for a first set of beams using at least part of the configuration information to obtain a first set of beam measurements;
compare the first set of beam measurements to predicted beam results, the predicted beam results obtained by inputting a second set of beam measurements into one or more AI/ML models used for the AI/ML based beam management, wherein a first periodicity of first resources for obtaining the first set of beam measurements is a multiple integer of a second periodicity of second resources for obtaining the second set of beam measurements; and
generate, for transmission to the base station, a monitoring report relating to the performance of the one or more models.

2. The apparatus of claim 1, wherein a third periodicity of third resources for transmitting the monitoring report is a multiple integer of the first periodicity.

3. The apparatus of claim 1, wherein a fixed offset in time is configured to link the first resources and the second resources.

4. The apparatus of claim 1, wherein an evaluation window is configured for obtaining the first set of beam measurements.

5. The apparatus of claim 4, wherein a first evaluation window for a first monitoring report is one of non-overlapping with a second evaluation window for a second monitoring report or overlaps with a second evaluation window for the second monitoring report.

6. The apparatus of claim 1, wherein a respective monitoring report is generated for each sample measurement of the first set of beams.

7. The apparatus of claim 1, wherein the first resources are configured by associating the second resources with a separate resource using CSI-AssociatedReportConfigInfo.

8. The apparatus of claim 1, wherein the monitoring report includes L1 reference signal received power (L1-RSRP) difference results.

9. The apparatus of claim 8, wherein, when a top K=1 best beam is reported, the reported value comprises (measured L1-RSRP of the best beam-predicted L1-RSRP), wherein the monitoring report is quantized with a finer quantization scheme than a L1-RSRP report.

10. The apparatus of claim 8, wherein, when top K>1 best beams are reported, the reported value comprises a mean, a sum, a maximum or a minimum of (measured L1-RSRP of the best beam—predicted L1-RSRP).

11. An apparatus comprising processing circuitry configured to:
process, based on signaling received from a base station, configuration information for monitoring a performance of one or more models employing artificial intelligence (AI) or machine learning (ML) (AI/ML) for beam management;
process measurements performed for a first set of beams using at least part of the configuration information to obtain a first set of beam measurements;
compare the first set of beam measurements to predicted beam results, the predicted beam results obtained by inputting a second set of beam measurements into one or more AI/ML models used for the AI/ML based beam management; and
generate, for transmission to the base station, a monitoring report relating to the performance of the one or more models, the monitoring report comprising an aperiodic monitoring report triggered by a first downlink control information (DCI).

12. The apparatus of claim 11, wherein first resources for obtaining the first set of beam measurements comprise multiple aperiodic resources triggered by the first DCI.

13. The apparatus of claim 11, wherein first resources for obtaining the first set of beam measurements comprise periodic or semi-persistent resources.

14. The apparatus of claim 13, wherein an evaluation window is configured for the first resources in CSI-AssociatedReportConfigInfo associated with the aperiodic monitoring report.

15. The apparatus of claim 11, wherein first resources for obtaining the first set of beam measurements comprise multiple aperiodic resources triggered by a second DCI.

16. The apparatus of claim 11, wherein first resources for obtaining the first set of beam measurements comprise multiple aperiodic resources triggered by the first DCI, the first DCI triggering a respective monitoring report for each of the multiple aperiodic resources, each respective monitoring report comprising a single bit.

17. The apparatus of claim 11, wherein first resources for obtaining the first set of beam measurements comprise multiple aperiodic resources triggered by the first DCI, the first DCI triggering the monitoring report after a last aperiodic resource of the multiple aperiodic resources, the monitoring report comprising a bitmap including a bit for each of the multiple aperiodic resources.

18. The apparatus of claim 11, wherein the monitoring report includes L1 reference signal received power (L1-RSRP) difference results.

19. The apparatus of claim 18, wherein an evaluation window is configured for the first set of beams, wherein a respective monitoring report is generated for each sample measurement of the first set of beams or a single monitoring report is generated comprising an average over the evaluation window.

20. The apparatus of claim 11, wherein the predicted beam results comprise temporal predictions for future slots, wherein each future slot is calculated separately.
